(19) United States
(12) Patent Application Publication
(10) Pub. No.: US 2010/0201536 A1
(43) Pub. Date: Aug. 12, 2010

(54) SYSTEM AND METHOD FOR ACCESSING A STRUCTURE USING A MOBILE DEVICE

(76) Inventors: William Benjamin Robertson, Monticello, IN (US); Robert P. Barden, Valley Center, KS (US); Cortland Denver Starrett, Brookston, IN (US)

Correspondence Address: Woodard, Emhardt, Moriarty, McNett & Henry LLP, 111 Monument Circle, Suite 3700, Indianapolis, IN, 46204-5137, US

(21) Appl. No.: 12/368,601

(22) Filed: Feb. 10, 2009

(51) Int. Cl. G08B 21/00; G08B 29/00

(52) U.S. Cl. 340/686.6; 340/5.61

(57) ABSTRACT

A wireless device access system employs short-range wireless communication to detect the proximity of a user device to a structure and a wide-area data network to communicate an unlock request. The access system then authenticates the unlock request and the proximity of the user device prior to transmitting an unlock command to the structure. Additionally, the wireless device may require the proximity of a user token prior to operation and/or the access system may include an override within the structure blocking any unlock command. Besides providing access to the structure, the system may perform other functions, such as monitoring room occupancy, switching power on and off, and the like.

### FIELD OF THE INVENTION

The present invention generally relates to an access system including a wireless user device and a proximity verification device. More particularly, the present invention pertains to an access system which receives a request for access from a mobile phone over a data network.

### BACKGROUND

In the United States alone there are more than 4.5 million hotel rooms available to travelers. Currently, these hotel rooms have an industry-wide occupancy rate of just over 60%, with the occupancy rates of various geographic areas and individual hotels varying wildly. This occupancy rate often drastically affects the bottom line of a hotel or hotel chain. To increase their occupancy rate, and thus their profitability, hotels make every attempt to please their guests in order to encourage them to return. In order to please their guests, and lure new ones, hotels have continuously added amenities, such as on-site spas, restaurants, fitness centers, and in-room coffee machines or mini-bars.

In addition to these additional amenities, hotels have adopted a variety of different check-in procedures to minimize the time required for a guest to check-in. These procedures include adopting electronic key cards as opposed to mechanical keys, which enhances guest security and allows the hotel to change to a new room key, alleviating the need for the guest to return the keys to the front desk at check-out. However, even these procedures still present a distracting delay to a hotel's most valuable customers, business travelers. To increase loyalty amongst these frequent travelers, among others, most major hotel chains have invested tremendous assets in developing rewards programs, such as the Hilton HHonors® Program. The goal of these programs is to allow hotel chains to better understand the needs of travelers and make their stay as streamlined as possible. For instance, some hotels provide express check-in for a select set of their guests, while others provide check-in/check-out over the Internet or via a computer kiosk located in the hotel lobby. While these advances have certainly increased the occupancy rates of the various major hotel chains, they have not yet solved the problem of fully automating the guest check-in/check-out process, thereby allowing a guest to arrive at their hotel and enter their room without any additional time-consuming steps.

### BRIEF DESCRIPTION OF THE DRAWINGS

FIG. 1 is a diagrammatic view of an access system according to one implementation of the present invention.

FIG. 2 is a process flow diagram illustrating one set of steps performed in enabling a user to access a structure using a wireless device and the novel access system.

FIG. 3 is a process flow diagram illustrating one set of steps performed in providing access to structure to a user using a wireless device and the novel access system.

FIG. 4 is a diagrammatic view of a token suitable for use in one embodiment of the present invention.

### DETAILED DESCRIPTION

For the purposes of promoting and understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Currently, systems exist, such as the Signature RFID/NFC system from VingCard, which provide a user access to a hotel room using their mobile phone. However, such systems all require a specialized transceiver within the door of the hotel room and the user's mobile phone such that the two may communicate using a short-range wireless technology. Retrofitting each of the guest room doors in a hotel can be very expensive and ultimately cost prohibitive. In addition, only a slight fraction of existing mobile phones are currently capable of being used with such systems, and it may be quite some time before such technology is common, if ever.

Other technologies exist for remotely allowing a user to monitor and control the open or closed state of an entryway, such as a garage door, using a cell phone connected to a controller over the Internet. However, these technologies do not provide sufficient security as they are designed for purposes other than secure access control. For example, these systems allow a user to send a command to open a door from any location where they have Internet access. As such, many problems exist in the prior art which are solved by the secure access system of the present invention.

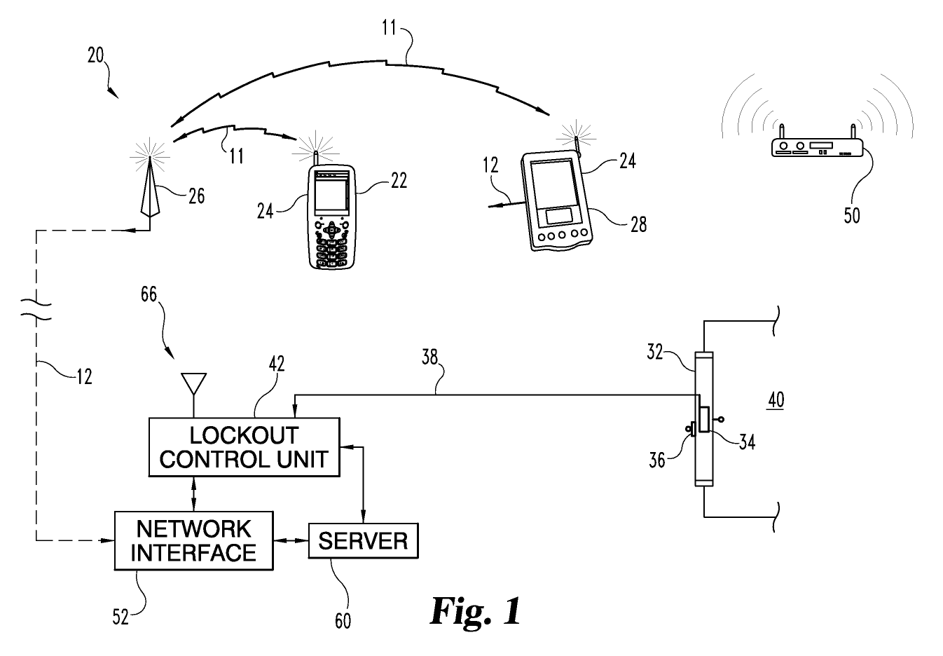

As shown in FIG. 1, one embodiment of an access system 20 advantageously permits a user to access a structure 40 using an Internet enabled wireless device 24. In addition to lodging and workplace access systems, it will be appreciated that similar embodiments of the access system to be described also encompass systems for controlling access to other structures or openings/doors thereof. In the illustrated embodiment, according to FIG. 1, the described system comprises an access system 20 for allowing a hotel guest to access their assigned hotel room using a wireless device 24, which in the preferred form, is the user's Internet enabled cell phone 22 or other wireless appliance 28. As such, it will be understood that many of the descriptions herein are meant for illustrative purposes and that the concepts herein are generally applicable to a general safety and security access system and are not limited to only a hotel room access system. Examples of other structures for which the novel access system may be adapted include other rooms within a hotel (i.e. workout rooms, pools, VIP lounges), office buildings, school/university buildings, warehouses, and portions thereof, event ticket gates/turnstiles, movie theatres, safety deposit boxes, mailboxes, lockers, or other enclosures for which providing selective user access is desired.

In addition, as explained later, access system 20 may also provide the user with various features including, but not limited to, automated check-in/check-out via an electronic kiosk or their wireless device, access to restricted members-only areas or lounges, and the like. Other features of access system 20 include the ability to request various reports on activity relating to the entry of various structures. Illustratively, some embodiments of the access system 20 allow the system to provide an activity log that reports the access requests during a specified period of time or for a specified user.

As shown in FIG. 1, according to the illustrative embodiment, the access system 20 interfaces with one or more wireless devices 24, such as cell phone 22 or wireless appliance 28, to allow a user to access their assigned hotel room. Cell phone 22 is preferably a long-range mobile phone used for mobile voice or data communication over a network of cell towers. In addition to the standard voice function of a mobile phone, cell phone 22 preferably supports many additional services, and accessories, such as SMS for text messaging, email, packet switching for access to the Internet, Bluetooth, infrared, and GPS.

Illustratively, in some embodiments, the access system 20 is operably coupled to data network 12. Data network 12 is preferably the Internet, which is a TCP/IP based global network; however, the user of the term “Internet” herein shall be understood to refer to at least a portion of any interconnected electronic network which interchanges data by packet-switching or some other technology.

More specifically, access system 20 utilizes cellular phone network 11 and data network 12 to interface with a wireless device 24, such as cell phone 22. Cellular phone network 11 may comprise a variety of communication networks, including without limitation the universal mobile telecommunications system (UTMS), global system for mobile communication (GSM), and a code division of multiple access (CDMA) network, or similar technology. Cellular phone network 11 utilizes cell tower 26 to establish a wireless bi-directional transmission link between data network 12 and cell phone 22, which may comprise a wireless data link, such as the Evolution-Data Optimized (EVDO), Enhanced Data rates for GSM Evolution (EDGE), 3G, 4G, LTE, WiMax, or other wireless data connection. Similarly, other wireless appliances 28, such as Palm, Samsung, and Motorola smartphones or other portable wireless appliances such an the iPod Touch or Microsoft Zune may be configured to connect to access system 20 through data network 12 to allow a user to access their hotel room.

Access system 20 additionally comprises a mechanical lock 34 operably coupled to a lock control unit 42 via connection 38 for locking and unlocking a structure 40 (partially shown). In the illustrated embodiment, a user gains access to the structure 40 via door 32. In the illustrative embodiment, mechanical lock 34 is a simple mechanical door lock, which includes a locking mechanism similar to a common entry or exterior lock, but is further capable of self-unlocking in response to a signal sent from a remote source. For purposes of non-limiting example, mechanical lock 34 may include a cam lock, rotary latch, electromechanical lock, magnetic lock, or the like. According to the preferred form, lock 34 unlocks in response to an electrical signal sent from a control. In one form, the electrical signal is sent wirelessly. In a further preferred form, the lock 34 returns to a locked state following the passage of a predetermined time period or a user opening and closing the door following the receipt of an unlock signal. In some additional forms, door 40 or lock 34 may also include a mechanical key slot, key card, or other entry permitting authentication means 36 in addition to, or as backup for, that described herein with respect to lock 34. In addition, it shall be appreciated that system 20 may be applied to access restrictions other than locks including, for example, an elevator control system providing limited access, a garage door, or others access barriers, as described later.

Lock control unit 42 is preferably a remote lock control device connected to one or more locks, such as hotel door locks, for allowing an authorized user to remotely unlock a selected hotel door. In the illustrated embodiment, lock control unit 42 is connected to lock 34, among others, to provide access to structure 40. Among other features, in some embodiments, lock control unit 42 comprises, for example, microprocessors, computers, microcontrollers, state machines, FPGA's, or other programmable logic devices. Some embodiments of lock control unit 42 also include logic units, static and dynamic memories, ROM, RAM, and flash. Likewise, lock control unit 42 may include memory systems: SRAM; DRAM; SDRAM; RAM BUS; flash; hard drives; CD drives; floppy drives; and other similar means of providing for memory access and storage. Other embodiments of lock control unit 42 comprise various I/O, networking and user interfaces including touch pads, means for data entry, display, display interfaces, networking interfaces, timers, clocks, internal clocks, counters, interrupt controllers, key generation peripherals, and communication ports as would be understood by those skilled in the art. In yet other embodiments, lock control unit 42 is a PC, laptop PC, or other programmable electrical machine. In alternate forms, lock control unit 42 may be a separate interface coupled to an existing dedicated remote locking/unlocking device or system, such as a hotel management system.

Illustratively, in some embodiments, lock control unit 42 is attached to a network interface 52 for connecting to various data network systems (including data network 12), to accept electronic unlock requests from an authorized server 60. Likewise, server 60 may be either operably coupled to network interface 52 or directly coupled to data network connection 12. These electronic requests are preferably received in addition to requests input via the standard user interface of lock control unit 42. Example network connections include: phone lines; cellular network; cable networks; wireless networks; DSL networks; satellite systems; Ethernet networks; and optical networks. It will be understood that some embodiments of data network 12 comprise the telephone system. Potential data network connections include interfaces to wireless, wired, or optical networks. In an alternate form, lock control network interface 52 may be integrated within lock control unit 42. Still other embodiments of lock control unit 42 may include an interface to hotel management systems. Likewise, in some embodiments, control unit 42 is integrated into a hotel management system. In addition, in some embodiments, antenna 66 of control unit 42 may be used to operably couple the lock control unit 42 to lock 34 or data network 12.

According to the illustrated embodiment, server 60 operates to receive unlock requests from wireless devices 24 over data network 12. In one form, the server 60 serves to authenticate the request or a portion thereof, while in another form, the wireless device performs the authentication. Server 60 processes each request to communicate a corresponding unlock request to lock control unit 42, which then issues an electronic signal to the specified lock, permitting access to the structure. While server 60 is described and illustrated as being a server, it should be understood that server 60 may be any computer, including a client server arrangement. Server 60 may interface with lock control unit 42 by either a wireless or hardwired interconnection. Preferably, the connection is a secured connection. A non-limiting example list of potential interfaces includes IR, optical, RF, serial port, IP network, and USB. Additionally, server 60 and lock control unit 42 may be located at two different geographic locations.

Yet another feature of access system 20 further includes a server application. This allows an authorized user to interface with access system 20 by logging onto server 60 attached to data network 12. The server acts as an interface to lock control unit 42. The server application comprises, among other features, a user interface comprising unlock command functions which enable a remote service to transmit unlock requests to lock control unit 42.

Illustratively, in at least one embodiment, the server function runs on a remote server (not shown) connected to network 12. The user contacts the server by utilizing an automated web service or by directing a web browser to a web site comprising a user interface with a login prompt. Upon logging into the server, the server provides the user with a user interface to a specified access system 20.

Wireless access system 20 also includes wireless proximity node 50 which broadcasts a wireless signal. According to the illustrative embodiment, proximity node 50 broadcasts information which is linked to the location of the user device over a short-range wireless network, such as using RF. In the preferred form, proximity node 50 is a Bluetooth transmitter, positioned near the structure 40. However, in alternate forms, proximity node 50 may be any other short range wireless transmitter, such as one operating under 802.11, wireless USB, or some other similar technology. The location information broadcast by proximity node 50 is linked to the present/assigned location of the node. For example, a node on the fourth floor of a hotel in downtown Chicago may broadcast a unique hotel identifier coupled with an area code. Alternatively, the node may broadcast a single identifier which is then linked to its location by the wireless device 24 or server 60. In one form, proximity node 50 is fixed at a single position, but in an alternate form, proximity node 50 may be moveable, such as located within an elevator, and include a floor detector, so that the node may broadcast information linked to the appropriate floor upon which it is currently located. In a further form, a proximity node 50 is fixed within an elevator and connected to the elevator control system to allow the wireless device to communicate floor authorization information to node 50. As such, the wireless device 24 may broadcast a floor to which the user is authorized to access so that the user may select that floor. In a further form, the elevator may be automatically commanded to take the user to that floor by node 50. As such, the users is enabled to access the floor or may experience a touchless trip to the proper floor. In other alternate forms, cell tower 26 may serve as the wireless node by providing location information corresponding to the location of the user device, such as by using triangulation between multiple towers, assisted GPS, or some other localization technology, such as that accessible to the E911 system.

In still other embodiments, lock control unit 52 or lock 34 is operably coupled to an override switch (not shown) having an access disable state. Asserting the override switch prevents the access system 20 from permitting access to corresponding structure 40. As one non-limiting example, override switch may be asserted when a guest engages a deadbolt or bar latch within their hotel room. In some embodiments of the access system 20, the override switch is incorporated into an electronic control, not shown here, accessible to the user within structure 40.

A flowchart illustrating one set of steps performed in configuring a wireless device 24 for use in accessing a structure 40 according to one embodiment of the present invention is shown. The process involves a wireless device 24 and the various other components of access system 20. The following description is with continuing reference to access system 20 of FIG. 1. As shown in FIG. 1, the wireless device is cell phone 22; however, it is understood that other networked appliances are also intended. It shall be appreciated that while the process is described with respect to the reservation and check-in process common for a hotel and hotel room the novel access system could be adapted for application in various settings to provide for the same desired result. As such, the confirmation and check-in process may be replaced with an employee authorization process or the like depending upon the nature of the structure being utilized.

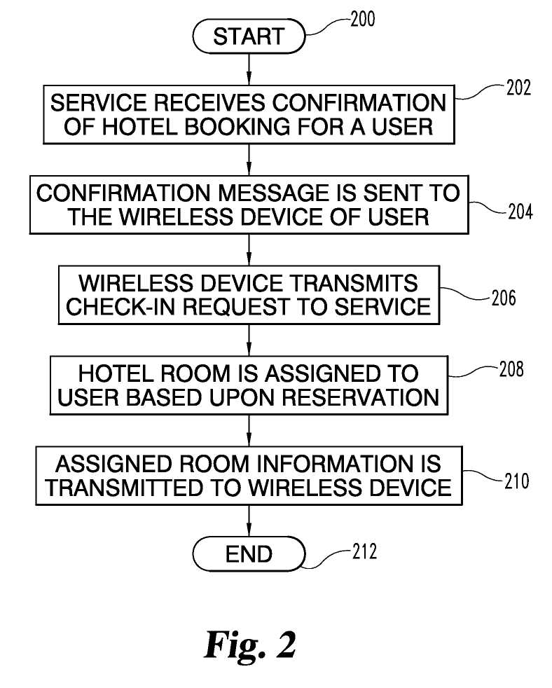

As shown in FIG. 2, the process begins at start point 200 with the novel service receiving confirmation of the booking of a hotel stay for a user (stage 202). The confirmation information preferably identifies the hotel and the user and includes a check-in/check-out date along with details of the type of room requested/reserved. In the preferred form, this confirmation information is received by server 60 as a result of a hotel booking being made for a user either online, in person, or over the phone.

Subsequent to receiving the confirmation information, a confirmation message is sent to the wireless device 24 of the user (stage 204). Preferably, a phone number or e-mail address corresponding to the user's wireless device is submitted along with the booking information. The confirmation message may be in the form of an e-mail, SMS, text message, or the like. The confirmation message includes a hotel identifier, user identifier, and a unique key or code. In the illustrated embodiment, the confirmation message is handled by an installable application on the user's wireless device 24 which is available for install to the user, such as via the hotel website, a third-party website, other application source, or download source indicated in the confirmation message. Preferably, the application is suitable for operation on various mobile operating systems including Microsoft Mobile, Symbian OS, Palm OS, Mobile Linux, Apple OSX (iPhone), and MXI. In other forms, the application used by wireless device 24 may be browser-based and/or embedded software, to name a few non-limiting examples.

In order to allow the user to access their room, a specific room must be assigned to the user. Traditionally, this has occurred either the day of check-in or during the check-in process. However, in the illustrative form, the user is assigned a specific room automatically upon arriving at the hotel. This occurs as a result of the wireless device 24 associated with the user transmitting a check-in request to server 60 (stage 206). The check-in request is preferably triggered by the user's wireless device 24 detecting a proximity node 50 within the hotel indicated by the hotel identifier of the confirmation message during the timeframe indicated by the check-in/checkout dates. Alternatively, the check-in request may be transmitted via an electronic kiosk in the hotel lobby, or an actual in-person check-in entered by a hotel representative. It is preferred that the check-in request be sent over data network 12 to server 60, however, it and others described herein may be sent through a local or private hotel network accessible by wireless device 24.

Upon receiving a check-in request, server 60 assigns a room matching the reservation of the user (stage 208). In the preferred form, this is accomplished by server 60 which interfaces with the hotel's management system. In addition, the server 60 associates the key code from the user's confirmation message with the assigned room. In an alternate form, step 208 may be omitted and the access system 20 may simply automatically assign a room to the user, as described above with respect to step 208, on the day of check-in absent an indication of the user's presence at the hotel or the like.

The details of the assigned room, including its number and location, are then sent in a return message to the user's wireless device 24 by server 60 (stage 210). This enables the user to send an electronic request for access to the hotel room using wireless device 24. In one form, an IP address is provided for sending the access request to. This address may be that of either server 60 or the lock control unit 42. The process ends at end point 212. It shall be appreciated that this process may be modified to accommodate more than one authorized hotel guest per room, such as having two wireless devices authorized to enter the same hotel room, or allowing a current guest to authorize the wireless device of another to access the hotel room for any portion of their remaining stay.

In continuing the description of the embodiment described with respect to FIG. 2, a flowchart illustrating one set of steps performed in allowing a user to access structure 40 using wireless device 24 and the various other components of access system 20 is shown. The following description is with continuing reference to access system 20 of FIG. 1 and the description accompanying FIG. 2.

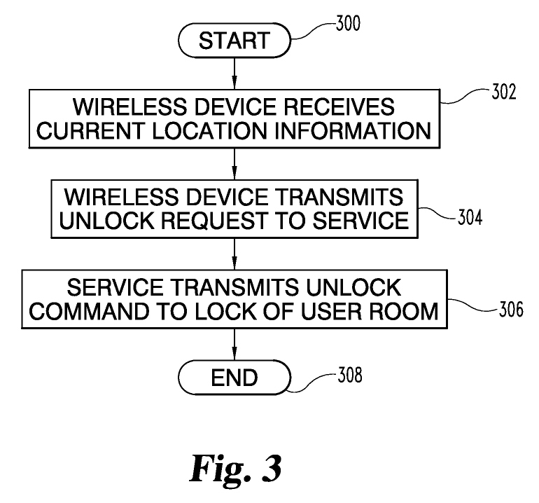

As shown in FIG. 3, the process begins at start point 300 with the wireless device 24 receiving location information linked to the current location of the user and wireless device 24 (stage 302). In one form, this location information is received or determined by wireless device 24 from wireless node 50 which is located near the user's assigned room (represented by structure 40). In the preferred form, wireless node 50 broadcasts a hotel identifier and a zone or area identifier which correspond to zones, such as floor, wings, or portions thereof in a hotel. In an alternate form, a unique identifier is broadcast by wireless node 50 which is then used as a lookup in a location table by wireless device 24 or by server 60. In a further form, the wireless device 24 “connects” with node 50 and transmits information identifying the device and/or the user to the node 50. Node 50 then communicated to server 60 that the node detected the presence of wireless device 24 at a set time. As a result, an added layer of security is provided by server 60 ensuring that the node 50 reported the presence of wireless device 24 before authenticating an unlock request received from the wireless device 24. In an alternate form, the identification of the wireless devices which connect with node 50 during a recent timeframe may be stored therein and communicated over network 12 in response to a request from server 60.

Depending upon the application, structure 40 may be within the broadcast range of wireless node 50, or the node 50 may be only located nearby, such as near the main elevator, stairway, hallway, or other essential entranceway. In the event structure 40 is not within the range of wireless node 50, the detection of wireless node 50 by user device 24 within a predetermined time period may be used to establish its proximity to structure 40. In a further form, the wireless node 50 is hidden and broadcasts encrypted information. The wireless device 24 is only able to identify and interpret the location information transmitted using access information transmitted to the user device by server 60 in conjunction with the confirmation or check-in information.

In an alternate configuration, the location information received by wireless device 24 is positional information sent by cell tower 26 over cellular network 11. This location information may be based upon assisted GPS, triangulation, or other known techniques, such as those accessible to the E911 system. In yet another configuration, GPS data obtained from a GPS device onboard wireless device 24, or some other location identifying source, such the XPS positioning system available from Skyhook Wireless of Boston, Mass.

Once the current position of the wireless device 24 is determined, such as its general location, the wireless device 24 transmits an unlock request to the IP address specified, such as server 60 (stage 304). In the illustrated embodiment, this request is sent through cell network 12, but it shall be appreciated that the message may also be sent through another wireless network, such as 802.11 or another similar technology. The unlock request may include any of the following: hotel ID, room number, location information, user name, reservation number, check-in/check-out dates. In addition, other information may be included in the request. According to one form, the application installed upon wireless device 24 determines that the user device is currently located in proximity to structure 40 prior to enabling an unlock request to be sent. This is accomplished by having authorized zones transmitted to the application during check-in. For example, a listing of wireless node identifiers or a range of GPS coordinates may be included. In an alternate form, the wireless device 24 is able to send an unlock request to server 60 after check-in, however, the unlock request includes the current location information received by wireless device 24, which is then authorized to determine the user's proximity to the structure 40 prior to acting upon it, as described below.

Once an unlock request is received by server 60, server 60 identifies the appropriate lock control unit and lock (such as lock control unit 42 and lock 34) and transmits and unlock command to the lock control unit (step 306). Upon receiving the unlock request, the lock control unit transmits an electronic signal to the appropriate lock which then unlocks the structure and enables the user operating wireless device 24 to enter. The process ends at end point 308.

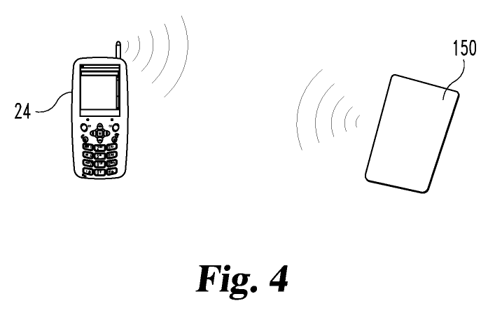

Turning to FIG. 4, a user node suitable for use in a further embodiment of the present invention is illustrated. User token 150 is device suitable for being queried by a wireless device 24. Token 150 is optionally provided to the user by the hotel or structure during authorization. Token 150 may include a coded unique identifier or some other verifiable data. Prior to sending any request, such as an unlock request, wireless device 24 may optionally be programmed to query for the presence of token 150 within its presence. In the event that a token 150 having the verifiable data is not found, then the request may be blocked. However, in the event the token 150 is within the proximity of wireless device 24 the request may be transmitted. As such, the user may be required to carry token 150 to ensure that wireless device 24 only functions with access system 20 when in the presence of the authorized user. According to this embodiment, token 150 is a passive Bluetooth node, but may be any other short-range wireless device, such as RFID or the like. Preferably, token 150 does not require its own power source.

In another form, access system 20 additionally comprises a parking access device (not shown) such as a garage door or parking gate coupled to lock control unit 42 selectively permitting access to a parking lot or structure (not shown). In this illustrated embodiment, a user is able to gain access to the parking area via the garage door or parking gate. According to the preferred form, the parking access device permits a user's vehicle access to the parking area in response to an electrical signal sent from a control device. In one form, the electrical signal is sent wirelessly.

In further systems, a proximity node, similar to node 50, may be included in other areas so as to permit a user to access structures, such as a hotel parking garage, based upon the confirmation information sent to their wireless device or other information as described herein. As such, the user's parking duration could be easily calculated and charged to their hotel bill.

In still further systems, a notification process may be executed by server 60 such that upon detecting a current hotel guest has left the hotel, a request for hospitality and cleaning services may be generated. In one form, the server 60 may detect a hotel guest leaving as a message sent from the user's wireless device upon passing by a proximity node located near the user's assigned room and another proximity node at one of the various exits to the hotel. Alternatively, the user opening the exit of the parking garage using their wireless device may trigger such a notification.

In yet another system, the wireless device may transmit information to server 60 upon passing a proximity node which indicates the user's entrance into the hotel or the area of their assigned hotel room. This information may trigger the in-room temperature to be raised to a user-specified or standard level or it may trigger the lights to be turned on, as described in U.S. patent application Ser. No. 10/126,486 to Sunyich entitled “Personalized Smart Room”, which is hereby incorporated by reference to the extent not inconsistent.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

What is claimed is:

1. An access system allowing a user to access a structure having a mechanical locking device using a wireless user device, the access system comprising:
an electronic lock control device for remotely controlling the mechanical locking device for locking and unlocking a structure; and
a server operable to send an unlock command associated with said mechanical locking device to said lock control device upon authenticating an unlock request received over the Internet from a wireless user device,
wherein said unlock request includes user information linked to said structure and is based upon location information received by the wireless user device from a wireless node which is linked to the current location of the wireless user device.

2. The access system according to claim 1, wherein said wireless node is a short-range radio-frequency transmitter located near said structure.

3. The access system according to claim 2, wherein said mechanical locking device is located within the transmission range of said wireless node.

4. The access system according to claim 2, wherein said wireless node is a Bluetooth transmitter.

5. The access system according to claim 1, wherein said wireless user device is a mobile telephone.

6. The access system according to claim 5, wherein said wireless node comprises a cellular phone tower.

7. The access system according to claim 6, wherein said location information is based at least upon GPS data received by said cellular phone tower.

8. The access system according to claim 7, wherein said location information is based upon assisted GPS data.

9. The access system according to claim 5, wherein said wireless node is a Bluetooth transmitter and said wireless user device includes a Bluetooth receiver.

10. The access system according to claim 1, wherein said wireless user device is a personal digital assistant (PDA).

11. The access system according to claim 1, wherein said structure is an enclosed room having a door secured by said mechanical locking device.

12. The access system according to claim 11, wherein said structure is a hotel room.

13. A method for facilitating user access to a structure using a wireless user device, the method comprising the steps of:
receiving electronic permission information indicating that a selected user device is authorized to unlock a structure having a mechanical locking device;
receiving a digital unlock request from a wireless user device over the Internet;
receiving an electronic signal from a verification circuit operable to confirm the proximity of the wireless user device to the structure;
authenticating that the wireless user device is the selected user device indicated in said electronic permission information; and
sending an electronic unlock command to said mechanical locking device so as to permit access to the structure.

14. The method of claim 13, wherein said receiving an electronic signal includes receiving information which originated from a short-range radio-frequency transmitter located near said structure.

15. The method of claim 14, wherein said short-range radio-frequency transmitter is a Bluetooth transmitter.

16. The method of claim 13, wherein said wireless user device is a mobile telephone.

17. The method of claim 16, wherein said mobile telephone is connect to the Internet.

18. The method of claim 16, wherein said receiving an electronic signal includes receiving information which originated from a cellular phone tower.

19. The method of claim 18, wherein said verification circuit utilizes GPS data received by said cellular phone tower.

20. The method of claim 19, wherein said GPS data is based upon assisted GPS data.

21. The method of claim 13, wherein said wireless user device is a personal digital assistant (PDA).

22. The method of claim 13, wherein said structure is an enclosed room having a door secured by said mechanical locking device.

23. The method of claim 22, wherein said structure is a hotel room.

24. The method of claim 23, further comprising the step of:
determining is a manual override switch located within said structure is asserted prior to said sending.

25. A method for facilitating user access to a structure using an Internet enabled wireless user device, the method comprising the steps of:
receiving electronic permission information indicating that a selected mobile phone is authorized to unlock a structure having a mechanical locking device;
receiving a digital unlock request from a mobile phone over the Internet;
receiving an electronic signal from a verification circuit indicating the proximity of the mobile phone to the structure based upon information received by the mobile phone from a short range wireless transmitter;
authenticating that the mobile phone is the selected mobile phone indicated in said electronic permission information; and
sending an electronic unlock command to said mechanical locking device so as to permit access to the structure.

26. A method for sending an electronic notification that a hotel room is available for maid service comprising:
receiving location data from one or more wireless nodes using a wireless user device, wherein said wireless user device is associated with a hotel guest assigned to a hotel room;
determining that the wireless user device has left the proximity of the hotel room based upon said location data; and
automatically sending an electronic notification to a specified server indicating that said hotel room is available for maid service in response to said determining.

27. The method of claim 26, wherein said determining includes determining that the wireless user device has left the proximity of a hotel associated with said hotel room based upon said location data.

28. The method of claim 26, wherein said receiving includes receiving location data from two unique wireless nodes.

29. The method of claim 26, wherein said one or more wireless nodes are cell towers.

30. The method of claim 26, wherein said location data is GPS data.

31. The method of claim 26, wherein said one or more wireless nodes are short-range wireless transmitters.

32. The method of claim 31, wherein said one or more wireless nodes are Bluetooth transmitters.
